(19) United States
(12) Patent Application Publication
(10) Pub. No.: US 2020/0270069 A1
(43) Pub. Date: Aug. 27, 2020

(54) FLEXIBLE AUTOMATED SORTING AND TRANSPORT ARRANGEMENT (FAST) ROBOTIC ARM

(71) Applicant: Walmart Apollo, LLC, Bentonville, AR (US)

(72) Inventors: Jason Bellar, Bella Vista, AR (US); William Mark Propes, Bentonville, AR (US); Chris Ford, Rogers, AR (US); Matthew D. Alexander, Rogers, AR (US)

(21) Appl. No.: 16/789,702

(22) Filed: Feb. 13, 2020

Related U.S. Application Data
(60) Provisional application No. 62/811,277, filed on Feb. 27, 2019.

(51) Int. Cl. B65G 47/49; B65G 47/91; B65G 47/82

(52) U.S. Cl. CPC B65G 47/493; B65G 47/91; B65G 2203/0216; B65G 2203/041; B65G 47/82

(57) ABSTRACT

A disclosed system for transporting items to destination locations, for example automatically placing stacked products at selected locations within a large retail facility, includes a conveyor assembly, an item identifier, a robotic arm with a plurality of end effectors, and a sorter component operable to select one of the plurality of end effectors and remove items selected for diversion from the conveyor assembly with the robotic arm. The sorter component stacks the removed items, and the stacked items are transported to a selected location within the retail facility, for example using an autonomous ground vehicle (AGV).

### BACKGROUND

In large retail settings, the unloading and placement of items (products) can be a significant aspect of operational efficiency. When inventory placement on a retail floor space varies, for example due to featured products, unloading and placement is affected. However, the loading on transport assets (e.g., trailers delivering the items) is often not coordinated with the product feature plans of the retail facility. Therefore, the affected items may be dispersed within the transport asset. This leads to potential errors and time wasted searching for misplaced items, thereby reducing operational efficiency.

### SUMMARY

A disclosed system for transporting items to destination locations, for example automatically placing stacked products at selected locations within a large retail facility, includes a conveyor assembly, an item identifier, a robotic arm with a plurality of end effectors, and a sorter component operable to select one of the plurality of end effectors and remove items selected for diversion from the conveyor assembly with the robotic arm. The sorter component stacks the removed items, and the stacked items are transported to a selected location within the retail facility, for example using an autonomous ground vehicle (AGV).

### BRIEF DESCRIPTION OF THE DRAWINGS

The disclosed examples are described in detail below with reference to the accompanying drawing figures listed below:

FIG. 1 illustrates an exemplary arrangement for transporting items to destination locations;

FIG. 2 illustrates a finer level of detail for some elements of the exemplary arrangement of FIG. 1;

FIG. 3 illustrates an exemplary sorter component for use within the arrangement of FIG. 1;

FIG. 4 illustrates an exemplary autonomous ground vehicle (AGV) controller for use within the arrangement of FIG. 1;

FIG. 5 shows a flow chart of operations associated with the exemplary arrangement of FIG. 1; and

FIG. 6 is a block diagram of an example computing node for implementing aspects disclosed herein.

Corresponding reference characters indicate corresponding parts throughout the drawings. Elements in the figures are illustrated for simplicity and clarity and have not necessarily been drawn to scale. For example, the dimensions and/or relative positioning of some of the elements in the figures may be exaggerated relative to other elements to help to improve understanding. Also, common but well-understood elements that are useful or necessary in a commercially feasible embodiment may not be depicted, in order to facilitate a less obstructed view.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum.

In large retail settings, the unloading and placement of items (products) can be a significant aspect of operational efficiency. When inventory placement on a retail floor space varies, for example due to featured products, unloading and placement is affected. However, the loading on transport assets (e.g., trailers delivering the items) is often not coordinated with the product feature plans of the retail facility. Therefore, the affected items may be dispersed within the transport asset. This leads to potential errors and time wasted searching for misplaced items, thereby reducing operational efficiency.

Therefore, a disclosed system for transporting items to destination locations, for example automatically placing stacked products at selected locations within a large retail facility, includes a conveyor assembly, an item identifier, a robotic arm with a plurality of end effectors, and a sorter component operable to select one of the plurality of end effectors and remove items selected for diversion from the conveyor assembly with the robotic arm. The sorter component stacks the removed items, and the stacked items are transported to a selected location within the retail facility, for example using an autonomous ground vehicle (AGV).

The robotic arm picks up and places (stacks) products (individually, or in cases or cartons) on a pallet or some other surface. Some examples of the robotic arm include multiple effectors such as a spatula and a pusher, a suction-cup array, a side-to-side gripper, and/or other tools. In some examples, a camera based computer vision (CV) component selects an appropriate effector based on item properties. In some examples, stored item descriptions are consulted to select the effector. A CV component or LIDAR sensor assists with stacking the products. Stacking options and configurations can vary due to an item's weight, size (dimensions), rigidity fragility, geometry, and other physical parameters. Other resources can be leveraged, for example, an inventory manager, a feature service, a store planner, a flexible automated sorting and transport arrangement (FAST) component that assists with managing unloading operations, a cargo manifest, and others. An exception handling component detects blockage, damage to the products, and stacking problems. An alert generated when the pallet is filled and a transport (e.g., an AGV) is needed to replace the filled pallet. This automated solution reduces errors and time wasted searching for misplaced items, thereby improving operational efficiency.

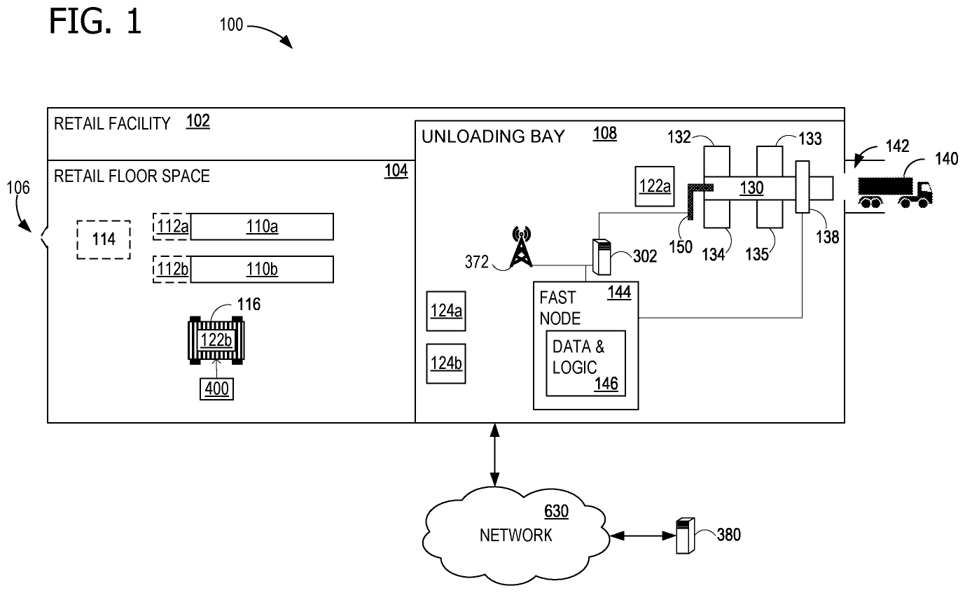

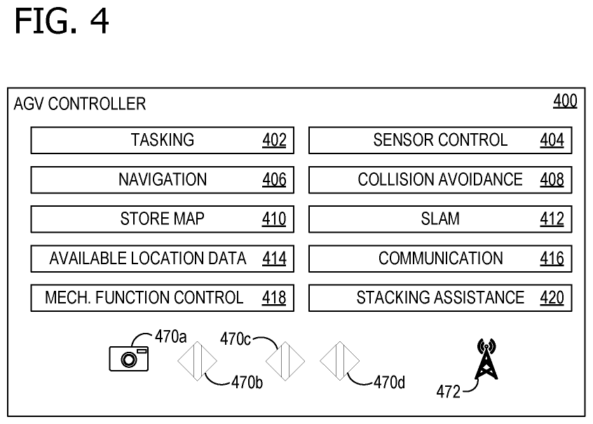

FIG. 1 illustrates an exemplary arrangement 100 for transporting items to destination locations, for example automatically placing stacked products at selected locations within a retail facility 102. Retail facility 102 has a retail floor space 104 having a front door 106; retail facility also has an unloading bay 108 where a transport asset 140 is sitting on dock location 142 for unloading. As illustrated, a full pallet 122b is being delivered by an AGV 116 that has an AGV controller 400, which is described in more detail in relation to FIG. 4. Retail floor space 104 has shelf units 110a and 110b with end cap display areas 112a and 112b, respectively. A feature floor space 114 is nearby front door 106. When a retail facility has a featured product, pallets of the featured product are often placed in end cap display areas 112a and 112b and/or feature floor space 114.

In unloading bay 108, a conveyor assembly 130 has multiple destination locations 132, 133, 134, and 135 where AGVs (e.g., AGV 116) collect items for normal inventory restocking processes. An item identifier 138 is operable to read identification data of items on conveyor assembly 130. A FAST node 144 manages and tracks progress for unloading operations. FAST node 144 has FAST data and logic 146 to support both normal inventory restocking processes and also transporting items to destination locations, as described herein. For example, FAST data and logic 146 includes a cargo manifest for transport asset 140, item descriptions, information on item size (dimensions) and weight, and also information related to stacking items (e.g., rigidity). FAST node 144 includes (or communicate with) an inventory manager having inventory data, and optionally includes a feature service and data. A store planning tool is available in some examples of FAST node 144. Some examples of FAST node 144 also control AGV 116 to instruct AGV 116 on placement of pallet 122b via a wireless communication module 372. FAST node 144 is in communication with a central hub 380 over a network 630 to receive information regarding inventory delivery and features. Central hub 380 coordinates logistics for inventory management among multiple retail facilities.

A sorting controller 302 is controlling a robotic arm 150 to remove items from conveyor assembly 130 and stack them on a pallet 122a. Robotic arm 150 has a plurality of end effectors. An end effector is a device or tool connected to the end of a robot arm. In some examples, available end effectors include a spatula and a pusher, a suction-cup array, and a side-to-side gripper. Empty pallets 124a and 124b are awaiting being taken to conveyor assembly 130 by AGV 116 and then loading by robotic arm 150.

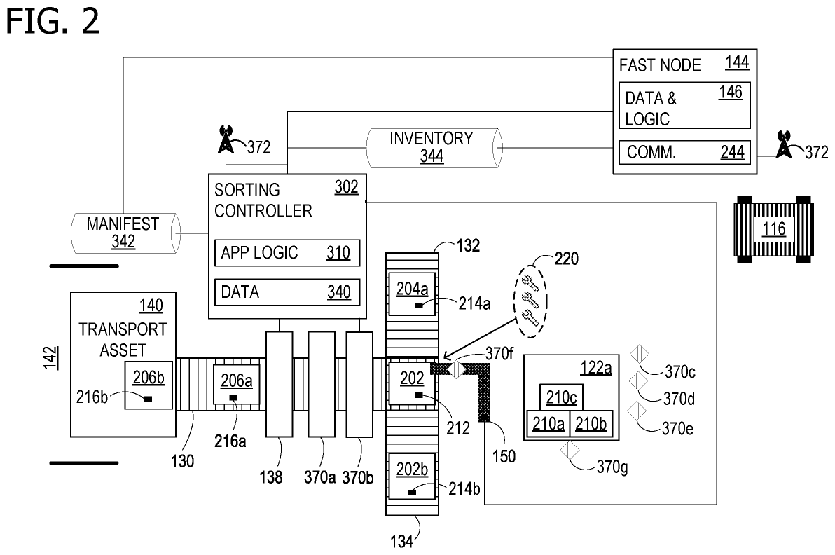

FIG. 2 illustrates a finer level of detail for some elements of arrangement 100. Conveyor assembly 130 is being used for unloading items from transport asset 140 in dock location 142. Destination locations 132 and 134 are shown. A first item 202 has an identification tag 212, and is about to be removed from conveyor assembly 130 by robotic arm 150. This is because first item 202 has passed by item identifier 138, which is operable to read identification data of first item 202 from identification tag 212, and sorting controller 302 as determined that first item 202 is to be diverted to a feature display. Therefore, sorting controller is controlling robotic arm 150 to remove first item 202 from conveyor assembly 130 and stack first item 202 on pallet 122a, at the first destination location. Item identifier 138 has also read identification data of second item 204a from identification tag 214a and sorting controller 302 as determined that second item 204a is not to be diverted to a feature display. Therefore, sorting controller 302 and FAST node 144 are, based at least on the identification data of second item 204a, routing second item 204a to destination location 132 on conveyor assembly 130. Also, based on identification data of third 204b from identification tag 214b, third item 204b is being routed to destination location 134. Item identifier 138 will soon be reading identification data of fourth item 206a from identification tag 216a, and will read identification data of fifth item 206b from identification tag 216b, when fifth item 206b is unloaded from transport asset 140.

FAST node 144 has a communication component 244 that works with wireless communication module 372 to control AGV 116 in support of unloading and inventory restocking operations. Also, in support of the operations, FAST node 144 accesses, or has within data and logic 146, a cargo manifest 342 identifying items brought by transport asset 140, inventory data 344 for the retail facility 102, and information for the items 202, 204a, 204b, 206a, and 206b that relate to the operations described herein. Such information includes item descriptions, for example size (dimensions), weight, information related to stackability, and identification of products on feature.

Robotic arm 150 has a plurality of end effectors 220, which includes at least two end effectors selected from the list consisting of: a spatula and a pusher, a suction-cup array, and a side-to-side gripper. Several sensors are shown. Sensors 370a and 370b identify physical parameters of item 202, such as size and weight. In some examples, sensors 370a and 370b provide a CV component and a weight measurement component. Using data from sensors 370a and 370b sorting controller 302 can select one of the plurality of end effectors 220 for engaging first item 202 with robotic arm 150. Sensors 370c, 370d, and 370e are configured to provide information to enable sorting controller 302 to determine stacking success on pallet 122a. For example, sensors 370c, 370d, and 370e provide CV or LIDAR components that assess the shape of the stack of items 210a, 210b, and 210c, that robotic arm 150 has already stacked in pallet 122a. Sensor 370f is on robotic arm, and thus may actually take the place of two sensors, because it moves with robotic arm. When sensor 370f is aimed at conveyor assembly 130, sensor 370f can take the place of either sensor 370a or 370b. When sensor 370f is aimed at pallet 22a, sensor 370f can take the place of one of sensors 370c-370e. Sensor 370g provides information on the position of pallet 122a, so that robotic arm 150 can be instructed regarding the bounding volume of where to stack items.

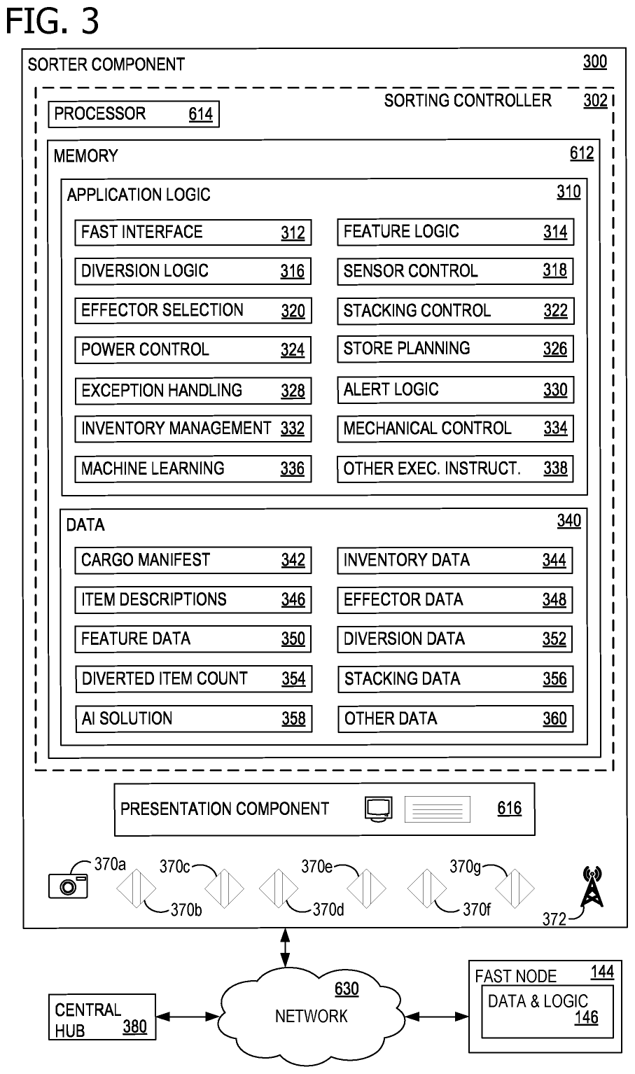

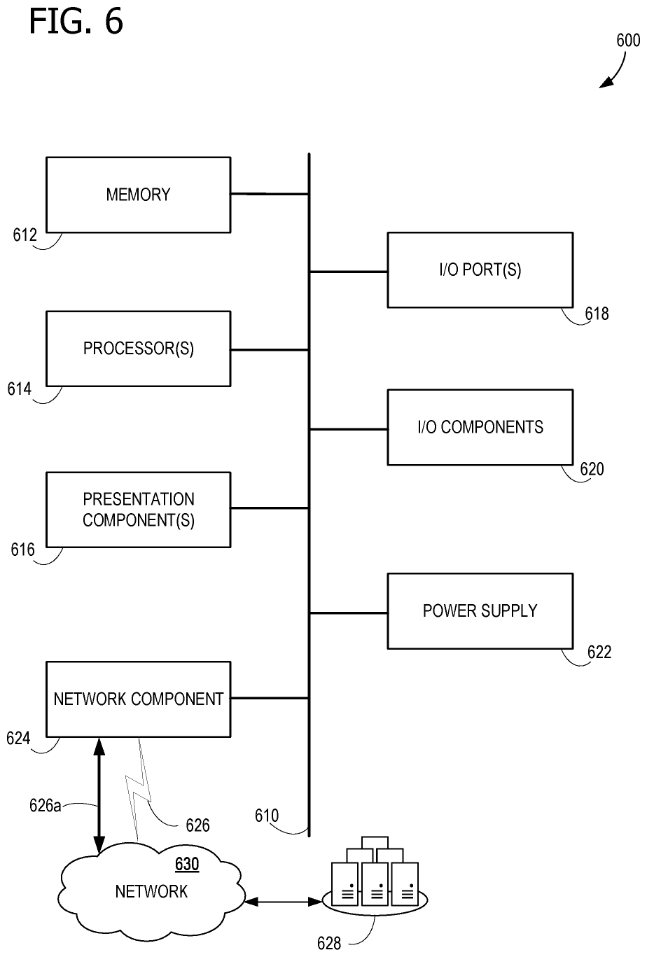

FIG. 3 illustrates a sorter component 300 for use with arrangement 100 (of FIG. 1). Sorter component 300 includes sorting controller 302, which has a processor 614 and a memory 612 holding application logic 310 and data 340. Sorter component 300 also includes a presentation component 616 (described in more detail in relation to FIG. 6) for interfacing with human users, a plurality of sensors 370a-370g, and wireless communication module 372. Sorting controller 302 communicates with FAST node 144 using a FAST interface 312, to obtain data used in the operations described herein for sorter component 300. This data includes cargo manifest 342, inventory data 344, and item descriptions 346. Sorter component 300 also communicates with central hub 380 over network 630 to retrieve other data, which is stored in other data 360. Feature data 350 is obtained from at least one of FAST node 144 and central hub 380.

Feature logic 314 is used to manage product feature operations, such as identifying locations to place pallets of featured products. Diversion logic 316 determines whether to divert an item with robotic arm 150, using diversion data 352 and a diverted item count. For example, if an item is not on the feature list (e.g., not in feature data 350), it will not be selected for diversion, but instead will be handled according to normal inventory restocking processes. If the item is on the feature list (e.g., it is identified in feature data 350), but the specified number of items have been diverted (e.g., diverted item count 354 has met a threshold), it will not be selected for diversion, but instead will be handled according to normal inventory restocking processes. Such a situation could arise of feature data 350 specified both items for feature and also a number to put in feature displays. As the items are stacked by robotic arm 150, diversion item count increments. When the threshold is met (the number specified in feature data 350), later unloaded items are handled according to normal inventory restocking processes. Also, if the item is on the feature list, but is damaged, it will not be selected for diversion (due to the damage), but instead will be handled according to normal damaged inventory processes.

A sensor control component 318 controls sensors 370a-370g. As illustrated, sensor 370a is a CV sensor, and eight sensors are shown. Other sensor options include LIDAR, weight sensors, mechanical force measurement sensors, and barcode readers, although it should be understood that different numbers and types of sensors may be used in various examples. Example sensors used by sorter component 300 include a first sensor component configured to determine a first physical parameter of items, and a second sensor component configured to determine a second physical parameter of items. The first sensor component includes a first one of sensors 370a-370g and the necessary logic and data in sensor control component 318. A physical parameter can be dimensions or weight. In some examples, determining the first physical parameter of ant item comprises sensing the first physical parameter with a CV component or a weight measurement component. A CV component can determine optical dimensional measurement and detect item damage.

A third, fourth, and fifth sensor component are configured to determine stacking success, for example by using CV or LIDAR placed at different angles (top, and two sides) to ascertain whether the stacking operations are producing a tilted stack. For example, a LIDAR sensor can produce a 3D point cloud that can be analyzed using a stacking control component 322 as items are stacked. A sixth sensor component, placed on robotic arm 150, so that it moves with the selected effector, can take the place of both the first sensor and one of the third through fifth sensor components. A seventh sensor component determines resistance force, or force feedback when robotic arm 150 is stacking an item. This can indicate a problem with the stack. An eighth sensor component identifies proper placement of a pallet.

Sorter component 300 receives identification data for items on conveyor assembly 30 from item identifier 138 for use in controlling robotic arm 150 in accordance with diversion logic. In some examples, sorter component 300 is operable to determine a physical parameter of an item using a stored item description in item descriptions 346. An effector selection component 320 receives physical parameter information about an item to be stacked, and consults effector data 348 to determine available effectors to use and which one is in current use. In this way, sorter component 300 is operable to, based at least on a first physical parameter of an item, select one of the plurality of end effectors for engaging the item with robotic arm 150. In some examples, selecting at least one end effector from a plurality of end effectors comprises selecting at least one end effector from the list consisting of: a spatula and a pusher, a suction-cup array, and a side-to-side gripper. Sorter component 300 is also operable to, based at least on the identification data of an item and item diversion data, control robotic arm 150 to remove the item from conveyor assembly 130 and stack the item at on pallet 122a. Sorter component 300 is also operable to control the stacking of the item on pallet 122a based at least on the first physical parameter of the item or a second physical parameter of the item. That is, sorter component 300 can select an end effector based on any of size, weight, and rigidity of an item, and then stack the item using either the same physical parameter(s), different physical parameter(s), or an overlap of physical parameters. Rules stored in stacking data 356, and used by stacking control 322 govern the height, shape, and weight of stacks. In some examples, stacking control 322 leverages an AI solution 358.

A power control component 324 is configured to, based at least on the weight of the first item, adjust power usage of robotic arm 150, for example by using less power when the item to be stacked is lightweight. A store planning component 326 determines locations in retail floor space 104 for full pallets (e.g., full pallet 122b). An exception handling component 328 detects and responds to at least one condition selected from the list consisting of: erroneous operation of conveyor assembly 130, damage to the first item (using CV), and stacking instability on pallet 122a. Stacking instability can be determined using force feedback (seventh sensor component) or analyze a 3D LIDAR point cloud or CV results (third through fifth sensor components). Additionally, some examples of exception handling component 328 take input from AGV 116, if AGV 116 detects stacking problems.

An alert logic 330 generates an alert when remaining capacity at pallet 122a is below a threshold. In some examples, the threshold is zero, and the alert is generated when pallet 122a is full. In some examples, the threshold is set to some number that provides some lead time for obtaining an empty pallet (e.g., empty pallet 124a or 124b), such as when there is room for only one or two more items on pallet 122a. An inventory management component 332 works with FAST node 144 and store planning component 326 to ensure that items are delivered to the correct locations within retail floor space 104 (e.g., shelf units 110a and 110b, end cap display areas 112a and 112b, and feature floor space 114). A mechanical control component 334 controls the electromechanical parts of robotic arm 150, such as servo motors and solenoids. An ML component 336 generates AI solution 358 to be used for improving stacking stability. To accomplish this, ML component 336 uses detected exception conditions previously detected and resolved by sorter component 300. Other executable instructions 338 includes, for example communication logic for communicating across network 630 or using wireless communication module 372.

FIG. 4 illustrates an AGV controller 400 for AGV 116. AGV controller has a tasking component 402 that receives tasking from sorting controller 302 and/or FAST node 144. A sensor control component 404 controls, receives, and stores data from sensors 470a-470d. As illustrated, sensor 470a is a CV sensor. Other sensor options include LIDAR, weight sensors, and barcode readers, although it should be understood that different numbers and types of sensors may be used in various examples. A navigation component 406 autonomously navigates AGV 116 throughout retail facility 102 using at least sensor 470a and a store map 410. A collision avoidance component 408 uses sensor 470b to prevent collisions between AGV 116 and other objects. AGV controller 400 has a simultaneous location and mobility (SLAM) component 412 that adapts store map 410 and identifies open available positions for pallets, using sensor 470c, as it navigates through retail floor space 104.

The open available positions for pallets is stored in available location data 414 and communicated to sorting controller 302 and/or FAST node 144 using a communication component 416 and a wireless communication module 472. A mechanical function control component 418 handles lifting and moving pallets, and driving and steering AGV 116. A stacking assistance component 420 uses sensor 470d to identify problems with stacking, such as leaning or instability, and communicates the feedback to sorting controller 302 via communication component 416 and wireless communication module 472.

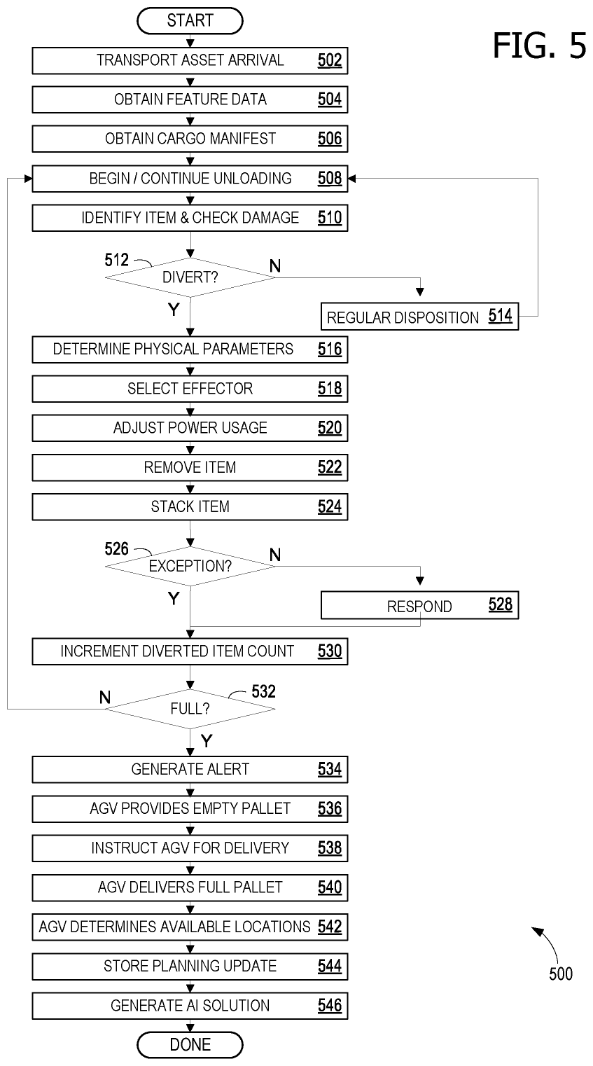

FIG. 5 shows a flow chart 500 of operations associated with arrangement 100. In some examples, some or all of flow chart 500 is performed as computer-executable instructions on a computing node 600 (see FIG. 6). Flow chart 500 commences when a transport arrives in operation 502. In general, a transport asset may include a trailer, a box truck, a flatbed truck, a pickup truck, an automated ground vehicle (AGV), a railway vehicle, an aerial vehicle, or any other motorized or towed conveyance. Feature data (e.g., feature data 350) is obtained in operation 504, and a cargo manifest (e.g., cargo manifest 342) is obtained in operation 506. In some examples, FAST node 144 provides at least a portion of the data obtained in operations 504 and 506. In some examples, data is obtained both locally and remotely (e.g., from central hub 380).

Unloading begins in operation 508, and operation 510 identifies an unloaded item and checks for damage. Specifically, operation 510 includes reading identification data of a first item on a conveyor assembly and identification data of a second item on the conveyor assembly. A CV component can check the item for damage, such as by using an AI solution. Decision operation 512 determines whether the item is to be diverted by the robotic arm. If the item is not on the feature list, it will not be selected for diversion, but instead will be handled according to normal inventory restocking processes. If the item is on the feature list, but the specified number of items have been diverted (e.g., diverted item count 354 has met a threshold), it will not be selected for diversion, but instead will be handled according to normal inventory restocking processes. If the item is on the feature list, but is damaged, it will not be selected for diversion (due to the damage), but instead will be handled according to normal damaged inventory processes. In either of these cases, flow chart 500 moves to operation 514 where, based at least on the identification data of the item, routing the item to a destination on the conveyor assembly where the item will be handled by normal inventory processes.

If, however, the item is to be diverted, then operation 516 includes determining a first physical parameter of the item. The first physical parameter may be size (dimensions), weight, shape, rigidity, fragility, or some other physical parameter. In some examples, determining the first physical parameter of the item comprises sensing the first physical parameter with a CV component or a weight measurement component. In some examples, determining the first physical parameter of the item comprises determining the first physical parameter using a stored item description (e.g., item description 346). Operation 518 includes selecting, based at least on the first physical parameter of the item, at least one end effector from a plurality of end effectors for engaging the item with a robotic arm. In some examples, selecting at least one end effector from a plurality of end effectors comprises selecting at least one end effector from the list consisting of: a spatula and a pusher, a suction-cup array, and a side-to-side gripper. For some examples, operation 520 includes, based at least on the weight of the item, adjusting power usage of the robotic arm. That is, if the weight is sufficiently low, the robotic arm can be operated in a low power mode, whereas, if the item is heavy, a higher power mode will be needed.

Operation 522 includes based at least on the identification data of the item and item diversion data, removing the item from the conveyor assembly with the robotic arm, and operation 524 includes stacking the item at the first destination location with the robotic arm. In some examples, stacking the item at the first destination location with the robotic arm comprises stacking the item based at least on data from a CV component. In some examples, stacking the item at the first destination location with the robotic arm comprises stacking the item based at least on the first physical parameter of the item or a second physical parameter of the item. For example, physical parameters such as size (dimensions), weight, shape, and rigidity can all affect stacking options. In some example, a rules engine (e.g., stacking control 322 using stacking data 356) will control stacking operations by limiting height, weight, and shape of the resulting stack.

Decision operation 526 includes detecting at least one condition selected from the list consisting of: erroneous operation of the conveyor assembly, damage to the first item, and stacking instability at the first destination. Some examples use exception handling component 328. In some examples, if the items are being stacked on a pallet that is on an AGV (as opposed to a solo pallet that will later be retrieved by an AGV) the AGV will provide exception detection input (e.g., with stacking assistance component 420). If an exception condition is detected, then operation 528 includes responding to the condition (responding to at least one condition selected from the list consisting of: erroneous operation of the conveyor assembly, damage to the first item, and stacking instability at the first destination). Conditions that can trigger an exception include blockage of the conveyor assembly, item damage, and a sensor on the robotic arm providing force feedback above some threshold.

The number of items diverted for the feature display (e.g., diverted item count 354) is incremented in operation 530. Decision operation 532 determines whether the pallet is full or nearly full, so that another (likely empty) pallet can be brought in to replace the full one. If not, then flowchart returns to operation 508 for continued unloading. If the pallet is full or nearly full, then operation 534 includes generating an alert when the first destination location is below a remaining capacity threshold. In some examples, the threshold is zero, and the alert is generated when the pallet is full. In some examples, the threshold is set to some number that provides some lead time for obtaining an empty pallet, such as there is room for only one or two more items. A new pallet is provided by an AGV (or a human operator, in some examples), in operation 536.

Operation 538 includes instructing the AGV that is delivering the full pallet where to place it. In operation 540, the AGV delivers the full pallet, and in operation 542, the AGV determines available locations for other pallets (e.g., using SLAM component 412 with store map 410). In some examples, operation 538 includes instructing the AGV specifically where in a retail floor space to deliver the full pallet, whereas in some other examples, operation 538 includes instructing the AGV only to deliver the full pallet to the floor space, and the AGV either receives further instructions from another node or uses its SLAM capability to find a suitable location. In operation 544, information regarding space available for other pallets (e.g., available location data 414) is provided by the AGV, permitting a store planning update (e.g., using store planning component 326). Operation 546 includes generating an AI solution (e.g., AI solution 358) for stacking, using an ML component (e.g., ML component 336). To accomplish this, operation 546 uses detected exception conditions detected and resolved (in operations 526 and 528) that were related to stacking instability. In some examples, operation 546 also includes generating an AI solution for item damage recognition using an ML component.

### Exemplary Operating Environment

FIG. 6 is a block diagram of an example computing node 600 for implementing aspects disclosed herein and is designated generally as computing node 600. Computing node 600 is one example of a suitable computing environment and is not intended to suggest any limitation as to the scope of use or functionality of the invention. Neither should the computing node 600 be interpreted as having any dependency or requirement relating to any one or combination of components/modules illustrated. The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing nodes, etc. The disclosed examples may also be practiced in distributed computing environments, where tasks are performed by remote-processing devices that are linked through a communications network.

Computing node 600 includes a bus 610 that directly or indirectly couples the following devices: memory 612, one or more processors 614, one or more presentation components 616, input/output (I/O) ports 618, I/O components 620, a power supply 622, and a network component 624. Computing node 600 should not be interpreted as having any dependency or requirement related to any single component or combination of components illustrated therein. While computing node 600 is depicted as a seemingly single device, multiple computing nodes 600 may work together and share the depicted device resources. That is, one or more computer storage devices having computer-executable instructions stored thereon may perform operations disclosed herein. For example, memory 612 may be distributed across multiple devices, processor(s) 614 may provide housed on different devices, and so on.

Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 6 is merely illustrative of an exemplary computing node that can be used in connection with one or more embodiments. Distinction is not made between such categories as “workstation,” “server,” “laptop,” “hand-held device,” etc., as all are contemplated within the scope of FIG. 6 and the references herein to a “computing node” or a “computing device.” Memory 612 may include any of the computer-readable media discussed herein. Memory 612 may be used to store and access instructions configured to carry out the various operations disclosed herein. In some examples, memory 612 includes computer storage media in the form of volatile and/or nonvolatile memory, removable or non-removable memory, data disks in virtual environments, or a combination thereof.

Processor(s) 614 may include any quantity of processing units that read data from various entities, such as memory 612 or I/O components 620. Specifically, processor(s) 614 are programmed to execute computer-executable instructions for implementing aspects of the disclosure. The instructions may be performed by the processor, by multiple processors within the computing node 600, or by a processor external to the client computing node 600. In some examples, the processor(s) 614 are programmed to execute instructions such as those illustrated in the flowcharts discussed below and depicted in the accompanying drawings. Moreover, in some examples, the processor(s) 614 represent an implementation of analog techniques to perform the operations described herein. For example, the operations may be performed by an analog client computing node 600 and/or a digital client computing node 600.

Presentation component(s) 616 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly among multiple computing nodes 600, across a wired connection, or in other ways. Ports 618 allow computing node 600 to be logically coupled to other devices including I/O components 620, some of which may be built in. Example I/O components 620 include, for example but without limitation, a microphone, keyboard, mouse, joystick, game pad, satellite dish, scanner, printer, wireless device, etc.

In some examples, the network component 624 includes a network interface card and/or computer-executable instructions (e.g., a driver) for operating the network interface card. Communication between the computing node 600 and other devices may occur using any protocol or mechanism over any wired or wireless connection. In some examples, the network component 624 is operable to communicate data over public, private, or hybrid (public and private) using a transfer protocol, between devices wirelessly using short range communication technologies (e.g., near-field communication (NFC), Bluetooth® branded communications, or the like), or a combination thereof. Network component 624 communicates over wireless communication link 626 and/or a wired communication link 626a to a cloud resource 628. Various different examples of communication links 626 and 626a include a wireless connection, a wired connection, and/or a dedicated link, and in some examples, at least a portion is routed through the internet.

Although described in connection with an example computing node 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing nodes, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device or computing node when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary system for transporting items to destination locations comprises: a conveyor assembly comprising first destination location and a second destination location; an item identifier operable to read identification data of a first item on the conveyor assembly and identification data of a second item on the conveyor assembly; a robotic arm; a plurality of end effectors for the robotic arm; and a sorter component operable to: based at least on a first physical parameter of the first item, select one of the plurality of end effectors for engaging the first item with the robotic arm; based at least on the identification data of the first item and item diversion data, control the robotic arm to remove the first item from the conveyor assembly and stack the first item at the first destination location; and based at least on the identification data of the second item, route the second item to the second destination location on the conveyor assembly.

An exemplary method of transporting items to destination locations comprises: reading identification data of a first item on a conveyor assembly and identification data of a second item on the conveyor assembly; determining a first physical parameter of the first item; selecting, based at least on the first physical parameter of the first item, at least one end effector from a plurality of end effectors for engaging the first item with a robotic arm; based at least on the identification data of the first item and item diversion data, removing the first item from the conveyor assembly and stacking the first item at a first destination location with the robotic arm; and based at least on the identification data of the second item, routing the second item to a second destination location on the conveyor assembly.

One or more exemplary computer storage devices having computer-executable instructions stored thereon for transporting items to destination locations, which, on execution by a computer, cause the computer to perform operations comprising: reading identification data of a first item on a conveyor assembly and identification data of a second item on the conveyor assembly; determining a first physical parameter of the first item, wherein determining the first physical parameter of the first item comprises: sensing the first physical parameter with a computer vision (CV) component or a weight measurement component; or determining the first physical parameter using a stored item description; selecting, based at least on the first physical parameter of the first item, at least one end effector from a plurality of end effectors for engaging the first item with a robotic arm, wherein selecting at least one end effector from the plurality of end effectors comprises selecting at least one end effector from the list consisting of: a spatula and a pusher, a suction-cup array, and a side-to-side gripper; based at least on the identification data of the first item and item diversion data, removing the first item from the conveyor assembly and stacking the first item at a first destination location with the robotic arm, wherein stacking the first item at the first destination location with the robotic arm comprises stacking the first item based at least on data from a CV component; based at least on the identification data of the second item, routing the second item to a second destination location on the conveyor assembly; detecting and responding to at least one condition selected from the list consisting of: erroneous operation of the conveyor assembly, damage to the first item, and stacking instability at the first destination; and generating an alert when the first destination location is below a remaining capacity threshold.

Alternatively, or in addition to the other examples described herein, examples include any combination of the following:
the plurality of end effectors for the robotic arm include at least two end effectors selected from the list consisting of: a spatula and a pusher, a suction-cup array, and a side-to-side gripper;
the sorter component comprises a first sensor component configured to determine the first physical parameter of the first item;
the first sensor component comprises a CV component;
the sorter component comprises a weight measurement component configured to determine a weight of the first item; and a power control component configured to, based at least on the weight of the first item, adjust power usage of the robotic arm;
the sorter component is further operable to determine the first physical parameter of the first item using a stored item description;
the sorter component comprises a CV component, wherein the sorter component is further operable to control the stacking of the first item at the first destination location based at least on data from the CV component;
the sorter component is further operable to control the stacking of the first item at the first destination location based at least on the first physical parameter of the first item or a second physical parameter of the first item;
the sorter component comprises an exception handling component operable to detect at least one condition selected from the list consisting of: erroneous operation of the conveyor assembly, damage to the first item, and stacking instability at the first destination;
the sorter component is further operable to generate an alert when remaining capacity at the first destination location is below a threshold;
an ML component operable to generate an AI solution for stacking control;
selecting at least one end effector from a plurality of end effectors comprises selecting at least one end effector from the list consisting of: a spatula and a pusher, a suction-cup array, and a side-to-side gripper;
determining the first physical parameter of the first item comprises sensing the first physical parameter with a CV component or a weight measurement component;
determining the first physical parameter of the first item comprises determining the first physical parameter using a stored item description;
determining a weight of the first item and, based at least on the weight of the first item, adjusting power usage of the robotic arm;
stacking the first item at the first destination location with the robotic arm comprises stacking the first item based at least on data from a CV component;
detecting and responding to at least one condition selected from the list consisting of: erroneous operation of the conveyor assembly, damage to the first item, and stacking instability at the first destination location;
generating an alert when the first destination location is below a remaining capacity threshold; and
generating an AI solution using an ML component.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for transporting items to destination locations, the system comprising:
a conveyor assembly comprising first destination location and a second destination location;
an item identifier operable to read identification data of a first item on the conveyor assembly and identification data of a second item on the conveyor assembly;
a robotic arm;
a plurality of end effectors for the robotic arm; and
a sorter component operable to:
based at least on a first physical parameter of the first item, select one of the plurality of end effectors for engaging the first item with the robotic arm;
based at least on the identification data of the first item and item diversion data, control the robotic arm to remove the first item from the conveyor assembly and stack the first item at the first destination location; and
based at least on the identification data of the second item, route the second item to the second destination location on the conveyor assembly.

2. The system of claim 1 wherein the plurality of end effectors for the robotic arm include at least two end effectors selected from the list consisting of:
a spatula and a pusher, a suction-cup array, and a side-to-side gripper.

3. The system of claim 1 wherein the sorter component further comprises:
a first sensor component configured to determine the first physical parameter of the first item.

4. The system of claim 3 wherein the first sensor component comprises:
a computer vision (CV) component.

5. The system of claim 1 wherein the sorter component further comprises:
a weight measurement component configured to determine a weight of the first item; and
a power control component configured to, based at least on the weight of the first item, adjust power usage of the robotic arm.

6. The system of claim 1 wherein the sorter component is further operable to determine the first physical parameter of the first item using a stored item description.

7. The system of claim 1 wherein the sorter component further comprises:
a computer vision (CV) component, wherein the sorter component is further operable to control the stacking of the first item at the first destination location based at least on data from the CV component.

8. The system of claim 1 wherein the sorter component is further operable to control the stacking of the first item at the first destination location based at least on the first physical parameter of the first item or a second physical parameter of the first item.

9. The system of claim 1 wherein the sorter component further comprises:
an exception handling component operable to detect at least one condition selected from the list consisting of:
erroneous operation of the conveyor assembly, damage to the first item, and stacking instability at the first destination.

10. The system of claim 1 wherein the sorter component is further operable to generate an alert when remaining capacity at the first destination location is below a threshold.

11. A method of transporting items to destination locations, the method comprising:
reading identification data of a first item on a conveyor assembly and identification data of a second item on the conveyor assembly;
determining a first physical parameter of the first item;
selecting, based at least on the first physical parameter of the first item, at least one end effector from a plurality of end effectors for engaging the first item with a robotic arm;
based at least on the identification data of the first item and item diversion data, removing the first item from the conveyor assembly and stacking the first item at a first destination location with the robotic arm; and
based at least on the identification data of the second item, routing the second item to a second destination location on the conveyor assembly.

12. The method of claim 11 wherein selecting at least one end effector from the plurality of end effectors comprises selecting at least one end effector from the list consisting of:
a spatula and a pusher, a suction-cup array, and a side-to-side gripper.

13. The method of claim 11 wherein determining the first physical parameter of the first item comprises sensing the first physical parameter with a computer vision (CV) component or a weight measurement component.

14. The method of claim 11 wherein determining the first physical parameter of the first item comprises determining the first physical parameter using a stored item description.

15. The method of claim 11 further comprising:
determining a weight of the first item; and
based at least on the weight of the first item, adjusting power usage of the robotic arm.

16. The method of claim 11 wherein stacking the first item at the first destination location with the robotic arm comprises stacking the first item based at least on data from a computer vision (CV) component.

17. The method of claim 11 further comprising:
detecting and responding to at least one condition selected from the list consisting of:
erroneous operation of the conveyor assembly, damage to the first item, and stacking instability at the first destination location.

18. The method of claim 11 further comprising:
generating an alert when the first destination location is below a remaining capacity threshold.

19. The method of claim 11 further comprising:
generating an artificial intelligence (AI) solution using a machine learning (ML) component.

20. One or more computer storage devices having computer-executable instructions stored thereon for transporting items to destination locations, which, on execution by a computer, cause the computer to perform operations comprising:
reading identification data of a first item on a conveyor assembly and identification data of a second item on the conveyor assembly;
determining a first physical parameter of the first item, wherein determining the first physical parameter of the first item comprises:
sensing the first physical parameter with a computer vision (CV) component or a weight measurement component; or
determining the first physical parameter using a stored item description;
selecting, based at least on the first physical parameter of the first item, at least one end effector from a plurality of end effectors for engaging the first item with a robotic arm, wherein selecting at least one end effector from the plurality of end effectors comprises selecting at least one end effector from the list consisting of:
a spatula and a pusher, a suction-cup array, and a side-to-side gripper;
based at least on the identification data of the first item and item diversion data, removing the first item from the conveyor assembly and stacking the first item at a first destination location with the robotic arm, wherein stacking the first item at the first destination location with the robotic arm comprises stacking the first item based at least on data from a CV component;
based at least on the identification data of the second item, routing the second item to a second destination location on the conveyor assembly;
detecting and responding to at least one condition selected from the list consisting of:
erroneous operation of the conveyor assembly, damage to the first item, and stacking instability at the first destination location; and
generating an alert when the first destination location is below a remaining capacity threshold.
